(19) United States
(12) Patent Application Publication
(10) Pub. No.: US 2023/0096711 A1
(43) Pub. Date: Mar. 30, 2023

(54) RESIN COMPOSITION AND LAMINATED BODY

(71) Applicant: TDK CORPORATION, Tokyo (JP)

(72) Inventors: Hajime AZUMA, Tokyo (JP); Tatsuya ABE, Tokyo (JP); Junichi HOSHINO, Tokyo (JP)

(73) Assignee: TDK CORPORATION, Tokyo (JP)

(21) Appl. No.: 17/794,816

(22) PCT Filed: Mar. 31, 2021
(86) PCT No.: PCT/JP2021/013939

§ 371 Date: Jul. 22, 2022

(30) Foreign Application Priority Data
Mar. 31, 2020 (JP) 2020-064858
Mar. 31, 2020 (JP) 2020-064859
Mar. 31, 2021 (JP) 2021-059440
Mar. 31, 2021 (JP) 2021-059441

(51) Int. Cl. C08F 299/08; C09D 183/10

(52) U.S. Cl. CPC C08F 299/08; C09D 183/10

(57) ABSTRACT

A resin composition, wherein a resin component in the resin composition has a group represented by the following General Formula (11), (21) or (31) and a urethane bond:

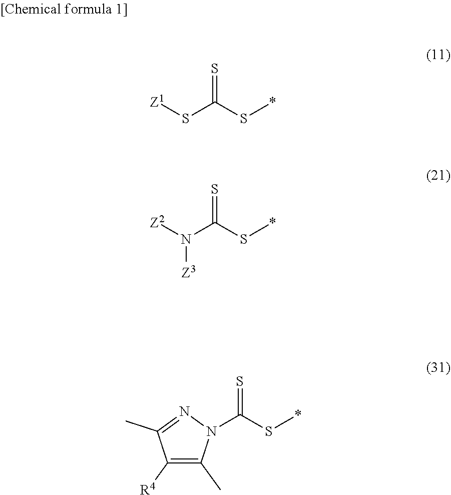

(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).

### TECHNICAL FIELD

The present disclosure relates to a resin composition and a laminated body.

Priority is claimed on Japanese Patent Application No. 2020-064859, filed Mar. 31, 2020, Japanese Patent Application No. 2020-064858, filed Mar. 31, 2020, Japanese Patent Application No. 2021-059440, filed Mar. 31, 2021, and Japanese Patent Application No. 2021-059441, filed Mar. 31, 2021, the contents of which are incorporated herein by reference.

### BACKGROUND ART

In recent years, with the development of flexible sensors, wearable devices that can manage physical conditions have been focused on. Wearable devices are intended for measurement and monitoring of specific parts of the body, and include those built into clothes and those that are directly attached to the skin in the fields of sports science and healthcare, and are expected to be applied in a wide range of applications. Since human skin repeatedly expands and contracts on a daily basis, it is desirable that the wearable device have stretchability corresponding to an object to be worn when stress-free wearability is required for the wearable device. In addition, it is desirable that the wearable device have a certain strength or more against stress generated during its bending or rolling up, assuming its handling by and movement of a person. In this specification, devices having such characteristics are not limited to wearable devices for applications and are referred to as stretchable devices.

Stretchable devices are assumed to include electrodes, devices, electronic components, thin film sensors and the like in stretchable elements, and need to maintain their quality even in a usage environment in which they repeatedly expand and contract. However, it is difficult to realize such a stretchable device with a polyimide sheet used in the conventional thin film resin substrate. For this reason, it is assumed that, among stretchable devices, elements and electrodes are mainly made of a resin supporting stretchability such as a urethane resin, a silicone resin, an acrylic resin, an epoxy resin, a polycarbonate, a polystyrene or a polyolefin as a constituent material. Among these, it is said that a stretchable film, which is a cured product of a composition containing a (meth)acrylate compound having a siloxane bond, a (meth)acrylate compound having a urethane bond other than a (meth)acrylate compound, and an organic solvent having a boiling point range of 115° C. to 200° C. at atmospheric pressure and in which the (meth)acrylate compound having a siloxane bond is unevenly distributed on the surface side of the film, has the same excellent stretchability and strength as polyurethane, and the film surface has the same excellent water repellency as silicone (refer to Patent Document 1).

### CITATION LIST

### Patent Literature

[Patent Document 1]
Japanese Unexamined Patent Application, First Publication No. 2017-206626

### SUMMARY OF INVENTION

### Technical Problem

However, as described in Patent Document 1, in the case of a resin sheet (resin film) whose main constituent material is a cured product of a resin composition, when a curing reaction does not proceed uniformly, there are problems that variations in the composition and degree of curing occur in the resin sheet, and the resin sheet does not have desired characteristics of stretchability, strength and resistance against deterioration over time.

The present disclosure has been made in view of the above problems, and an object of the present disclosure is to provide a resin composition for producing a resin sheet that can form a stretchable device which is a resin composition that enables the resin sheet to be produced without performing a curing reaction, and a laminated body including the resin sheet.

### Solution to Problem

In order to solve the above problem, the present disclosure has the following configurations.

[1] A resin composition, wherein a resin component in the resin composition has a group represented by the following General Formula (11), (21) or (31) and a urethane bond:

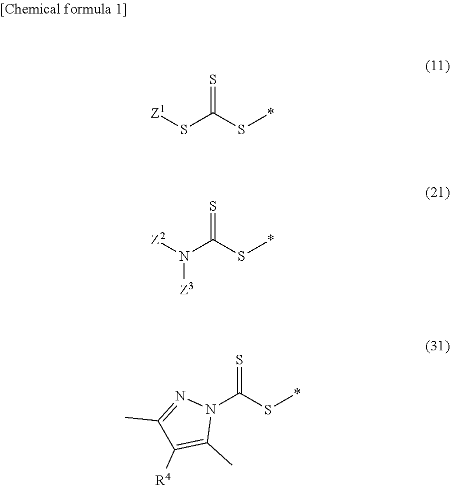

(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).
[2] The resin composition according to [1], wherein a viscosity of a butyl carbitol acetate solution containing 15 mass % of the resin composition is 0.07 to 22.35 Pas, when the butyl carbitol acetate solution is adjusted to a temperature of 25° C. and the viscosity of the butyl carbitol acetate solution is measured while stirring at a stirring speed of 10 rpm.
[3] The resin composition according to [2], wherein the resin composition contains a resin component having a weight average molecular weight of 61,000 to 250,000.
[4] The resin composition according to [1],

wherein the resin component in the resin composition further has a siloxane bond, and

the contact angle of a test resin sheet, which is obtained by solidifying the resin composition by drying, with respect to water is 77° to 116°.

[5] The resin composition according to [4], wherein the resin composition contains a resin component having a weight average molecular weight of 52,000 to 250,000.
[6] A laminated body including a resin sheet obtained by solidifying the resin composition according to any one of [1] to [5] by drying.
[7] The laminated body according to [6], in addition to the resin sheet, further including a substrate layer containing a resin.

### Advantageous Effects of Invention

Since the resin component contained in the resin composition of the present disclosure has a urethane bond, the resin sheet formed using the resin composition has favorable stretchability.

When the resin component contained in the resin composition of the present disclosure has a siloxane bond, the resin composition has appropriate water repellency, and hydrolysis of the urethane bond in the resin component is minimized. Therefore, deterioration of the resin sheet over time is minimized.

The resin component contained in the resin composition of the present disclosure is obtained by performing a polymerization reaction using an RAFT agent for performing reversible addition fragmentation chain transfer polymerization from which a group represented by General Formula (11), (21) or (31) is derived. When the polymerization reaction is performed in this manner, it is possible to prevent the resin during polymerization from gelling in a procedure of forming a cross-linked structure, and it is possible to obtain a resin component having a desired degree of polymerization and cross-linked state.

The resin sheet obtained using the resin composition of the present disclosure has a small variation in composition and has stretchability when the resin composition is produced by solidifying it by drying without curing it.

In addition, when the resin composition of the present disclosure has a siloxane bond, in the resin sheet obtained using the resin composition of the present disclosure, deterioration over time is minimized.

Therefore, for example, the resin sheet of the present disclosure is suitable for forming elements, wirings or electrodes in stretchable devices, and particularly, suitable for forming wirings or electrodes. In addition, the laminated body including the resin sheet of the present disclosure is suitable as a stretchable device, and also has high stability because structural defects, interfacial peeling and the like are minimized due to the effect of the resin sheet.

### BRIEF DESCRIPTION OF DRAWINGS

FIG. 1 is a schematic diagram showing an example of a laminated body according to one embodiment of the present disclosure.

### DESCRIPTION OF EMBODIMENTS

Hereinafter, the present disclosure will be described in detail. Materials, sizes and the like exemplified in the following description are examples, and the present disclosure is not limited thereto, and can be appropriately changed without changing the scope and spirit of the invention.

### First Embodiment

### “Resin Composition”

A resin composition of a first embodiment contains a resin component (in this specification, it may be referred to as a “resin component (TI)”), and the resin component has a group represented by the following General Formula (11), (21) or (31) and a urethane bond.

In the first embodiment, additionally, a viscosity of a butyl carbitol acetate solution containing 15 mass % of the resin composition is 0.07 to 22.35 Pa·s, when the butyl carbitol acetate solution is adjusted to a temperature of 25° C. and the viscosity of the butyl carbitol acetate solution is measured while stirring at a stirring speed of 10 rpm.

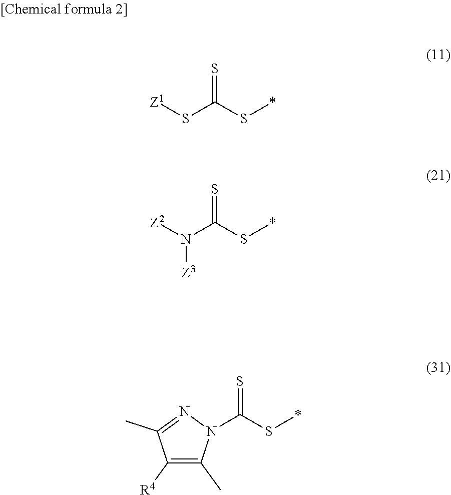

(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).

Since the resin component (II) contained in the resin composition of the first embodiment has a urethane bond, it has high flexibility.

In addition, the resin component (II) is obtained by performing a polymerization reaction using a resin having a urethane bond and a polymerizable unsaturated bond, and an RAFT agent for performing reversible addition fragmentation chain transfer polymerization (in this specification, it may be abbreviated as “RAFT polymerization”) from which a group represented by General Formula (11), (21) or (31) is derived. When the polymerization reaction is performed in this manner, it is possible to prevent the resin during polymerization from gelling in a procedure of forming a cross-linked structure, and it is possible to obtain a resin component having a desired degree of polymerization and cross-linked state. That is, the resin component (II) having a group represented by General Formula (11), (21) or (31) has a small variation in terms of the degree of polymerization and cross-linked state.

In addition, the resin component (ii) may have a siloxane bond, and in this case, the resin composition has appropriate water repellency, and hydrolysis of the urethane bond of the resin component (II) is minimized. Additionally, such a resin component (II) can be obtained by performing a polymerization reaction using a resin having a siloxane bond and a polymerizable unsaturated bond.

Here, a method of producing the resin component (II) for performing RAFT polymerization will be described in detail separately.

The resin having a urethane bond and a polymerizable unsaturated bond used for producing the resin component (II) is an oligomer, and may be referred to as a “resin (a)” in the first embodiment.

In addition, the resin having a siloxane bond and a polymerizable unsaturated bond used for producing the resin component (II) is an oligomer, and may be referred to as a “resin (b)” in the present embodiment.

The resin component (II) is a polymer produced by polymerizing the resins (a) with each other at their polymerizable unsaturated bonds. When the resin (b) is used, the resin component (II) is a polymer produced by polymerizing the resin (a) and the resin (b) at their polymerizable unsaturated bonds.

When the resin (b) is used, the resin component (II) preferably has both a urethane bond and a siloxane bond in one molecule thereof.

The resin (a) is not particularly limited as long as it has a urethane bond and a polymerizable unsaturated bond.

Regarding the resin (a), for example, those having a (meth)acryloyl group as a group having a urethane bond and a polymerizable unsaturated bond are preferable as exemplary examples, and more specifically, a urethane (meth)acrylate and the like are preferable as exemplary examples.

In this specification, “(meth)acrylate” refers to both an “acrylate” and a “methacrylate.” The same applies to terms similar to (meth)acrylate, and for example, “(meth)acryloyl group” refers to both an “acryloyl group” and a “methacryloyl group.”

The weight average molecular weight (Mw) of the resin (a) is preferably 3,000 to 50,000, and more preferably 15,000 to 50,000. When the resin (a) having such a weight average molecular weight is used, the resin component (II) having better characteristics can be obtained.

In this specification, “weight average molecular weight” is not limited to the case of the resin (a), and means a polystyrene-equivalent value measured by a gel permeation chromatography (GPC) method unless otherwise specified.

The resin (b) is not particularly limited as long as it has a siloxane bond and a polymerizable unsaturated bond.

Regarding the resin (b), for example, various known silicone resins having a (meth)acryloyl group as a group having a polymerizable unsaturated bond are preferable as exemplary examples, and more specifically, for example, a modified-polydialkylsiloxane having a (meth)acryloyl group bonded to one end or both ends of a polydialkylsiloxane such as polydimethylsiloxane is preferable as an exemplary example.

The number average molecular weight (Mn) of the resin (b) is preferably 400 to 10,000, and more preferably 5,000 to 10,000. When the resin (b) having such a number average molecular weight is used, the resin component (II) having better characteristics can be obtained.

In General Formula (11), Z¹ is an alkyl group.

The alkyl group for Z¹ may be linear, branched or cyclic, and is preferably linear or branched, and more preferably linear.

The linear or branched alkyl group for Z¹ preferably has 1 to 12 carbon atoms, and examples of such an alkyl group include a methyl group, ethyl group, n-propyl group, isopropyl group, n-butyl group, isobutyl group, sec-butyl group, tert-butyl group, n-pentyl group, isopentyl group, neopentyl group, tert-pentyl group, 1-methylbutyl group, 2-methylbutyl group, hexyl group, heptyl group, n-octyl group, isooctyl group, 2-ethylhexyl group, nonyl group, decyl group, undecyl group, and dodecyl group.

The linear or branched alkyl group for Z¹ may have, for example, 1 to 8, 1 to 5, or 1 to 3 carbon atoms.

The cyclic alkyl group for Z¹ may be monocyclic or polycyclic, and is preferably monocyclic.

The cyclic alkyl group for Z¹ preferably has 3 to 6 carbon atoms, and examples of such an alkyl group include a cyclopropyl group, cyclobutyl group, cyclopentyl group, and cyclohexyl group.

One or more hydrogen atoms in the alkyl group for Z¹ may or may not be substituted with a cyano group (—CN), a carboxy group (—C(═O)—OH) or a methoxycarbonyl group (—C(═O)—OCH₃).

When two or more hydrogen atoms in the alkyl group for Z¹ are substituted with a cyano group, a carboxy group or a methoxycarbonyl group, two or more of the substituents may be the same as or different from each other.

When the hydrogen atom is substituted with a cyano group, a carboxy group or a methoxycarbonyl group, all hydrogen atoms in the alkyl group may be substituted, and it is preferable that there be a hydrogen atom that is not substituted, and the number of hydrogen atoms substituted is preferably 1 or 2, and more preferably 1.

Regarding the alkyl group for Z¹ in which a hydrogen atom is substituted with a cyano group, a carboxy group or a methoxycarbonyl group, for example, a 1-carboxyethyl group (—CH(CH₃)COOH), 2-carboxyethyl group (—CH₂CH₂COOH), 4-carboxy-2-cyano-sec-butyl group (—C(CH₃)(CN)CH₂CH₂COOH), 2-cyano methoxycarbonyl-sec-butyl group (—C(CH₃)(CN)CH₂CH₂COOCH₃), 1-cyano-1-methylethyl group (—C(CH₃)(CN)CH₃), cyanomethyl group (—CH₂CN), 1-cyano-1-methyl-n-propyl group (—C(CH₃)(CN)CH₂CH₃), and 2-cyano-2-propyl group (—C(CH₃)(CN)CH₃) are preferable as exemplary examples, and a 2-carboxyethyl group is preferable.

Z¹ is preferably a dodecyl group (n-dodecyl group) or a 2-carboxyethyl group.

In General Formula (21), Z² is an alkyl group.

Examples of alkyl groups for Z² include the same alkyl groups as for Z¹.

The alkyl group for Z² is preferably linear or branched, and more preferably linear.

The linear or branched alkyl group for Z² may have, for example, 1 to 12, 1 to 8, 1 to 5, or 1 to 3 carbon atoms.

Z² is preferably a methyl group.

In General Formula (21), Z³ is an aryl group.

The aryl group for Z³ may be monocyclic or polycyclic, and is preferably monocyclic.

The aryl group for Z³ preferably has 6 to 12 carbon atoms, and examples of such an aryl group include a phenyl group, 1-naphthyl group, 2-naphthyl group, o-tolyl group, m-tolyl group, p-tolyl group, and xylyl group (dimethylphenyl group).

Z³ is a preferably a phenyl group.

In General Formula (31), R⁴ is a hydrogen atom or a halogen atom.

Examples of halogen atoms for R⁴ include a fluorine atom, a chlorine atom, a bromine atom, and an iodine atom, and a chlorine atom is preferable.

R⁴ is preferably a hydrogen atom or a chlorine atom.

In General Formula (11), (21) or (31), the bond with the symbol * is formed with the bonding destination of the group represented by General Formula (11), (21) or (31), that is, an end part in the polymer of the resin (a).

Examples of RAFT agents from which a group represented by General Formula (11) is derived include compounds represented by the following General Formula (1) (in this specification, it may be abbreviated as an “RAFT agent (1)”).

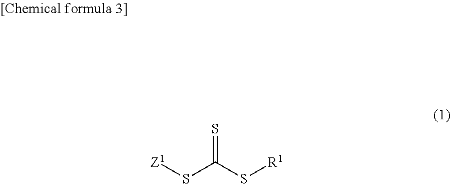

(in the formula, R¹ is an alkyl group, one or more hydrogen atoms in the alkyl group may be substituted with a cyano group, a carboxy group or a methoxycarbonyl group, and two or more of the substituents may be the same as or different from each other; and Z¹ is the same as described above).

Regarding the alkyl group in which one or more hydrogen atoms for R¹ in General Formula (1) may be substituted with a cyano group, a carboxy group or a methoxycarbonyl group, the same alkyl groups in which one or more hydrogen atoms for Z¹ may be substituted with a cyano group, a carboxy group or a methoxycarbonyl group is preferable as an exemplary example, and the mode of substitution of hydrogen atoms for R¹ is the same as the mode of substitution of hydrogen atoms for Z¹.

R¹ is preferably a 1-carboxyethyl group, 4-carboxy-2-cyano-sec-butyl group, 1-cyano-1-methylethyl group), 2-cyano-4-methoxycarbonyl-sec-butyl group, cyanomethyl group, or 2-cyano-2-propyl group.

Z¹ in General Formula (1) is the same as Z¹ in General Formula (11).

When the RAFT agent (1) is used, according to a polymerization reaction, a group represented by R¹ in General Formula (1) is bonded to an end part of the polymer of the resin (a) to which a group represented by General Formula (11) is not bonded.

Examples of RAFT agents from which a group represented by General Formula (21) is derived include compounds represented by the following General Formula (2) (in this specification, it may be abbreviated as an “RAFT agent (2)”).

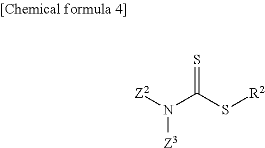

(in the formula, R² is an alkyl group, one or more hydrogen atoms in the alkyl group may be substituted with a cyano group, a carboxy group or a methoxycarbonyl group, and two or more of the substituents may be the same as or different from each other; and Z² and Z³ are the same as described above).

Regarding the alkyl group in which one or more hydrogen atoms for R² in General Formula (2) may be substituted with a cyano group, a carboxy group or a methoxycarbonyl group, the same alkyl groups in which one or more hydrogen atoms for Z¹ may be substituted with a cyano group, a carboxy group or a methoxycarbonyl group is preferable as an exemplary example, and the mode of substitution of hydrogen atoms for R² is the same as the mode of substitution of hydrogen atoms for Z¹.

R² is preferably a cyanomethyl group.

Z² and Z³ in General Formula (2) are the same as Z² and Z³ in General Formula (21).

When the RAFT agent (2) is used, according to a polymerization reaction, a group represented by R² in General Formula (2) is bonded to an end part of the polymer of the resin (a) to which a group represented by General Formula (21) is not bonded.

Examples of RAFT agents from which a group represented by General Formula (31) is derived include compounds represented by the following General Formula (3) (in this specification, it may be abbreviated as an “RAFT agent (3)”).

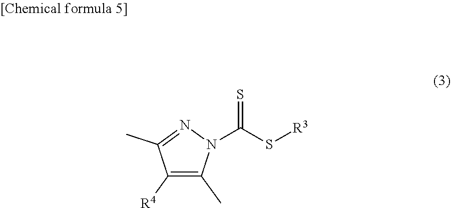

(in the formula, R³ is an alkyl group, one or more hydrogen atoms in the alkyl group may be substituted with a cyano group, a carboxy group or a methoxycarbonyl group, and two or more of the substituents may be the same as or different from each other; and R⁴ is the same as described above).

Regarding the alkyl group in which one or more hydrogen atoms for R³ in General Formula (3) may be substituted with a cyano group, a carboxy group or a methoxycarbonyl group, the same alkyl groups in which one or more hydrogen atoms for Z¹ may be substituted with a cyano group, a carboxy group or a methoxycarbonyl group is preferable as an exemplary example, and the mode of substitution of hydrogen atoms for R³ is the same as the mode of substitution of hydrogen atoms for Z¹.

R³ is preferably a cyanomethyl group or 1-cyano-1-methyl-n-propyl group.

R⁴ in General Formula (3) is the same as R⁴ in General Formula (31).

When the RAFT agent (3) is used, according to a polymerization reaction, a group represented by R³ in General Formula (3) is bonded to an end part of the polymer of the resin (a) to which a group represented by General Formula (31) is not bonded.

When the resin component (II) is produced, the resin (a), and as necessary, the resin (b) may be used, and additionally, other polymerizable components not corresponding to these may be used.

Regarding the other polymerizable components, for example, a monomer or oligomer having a polymerizable unsaturated bond is preferable as an exemplary example.

Regarding the other polymerizable components, more specifically, for example, (meth)acrylic acid alkyl esters such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, pentyl (meth)acrylate, hexyl (meth)acrylate, heptyl (meth)acrylate, 2-ethylhexyl (meth)acrylate, isooctyl (meth)acrylate, n-octyl (meth)acrylate, n-nonyl (meth)acrylate, isononyl (meth)acrylate, and decyl (meth)acrylate is preferable as an exemplary example.

Regarding the resin composition of the present embodiment, for example, those containing the resin component (II) and a solvent is preferable as an exemplary example, and additionally, as necessary, those containing other non-polymerizable components not corresponding to these is preferable as an exemplary example.

As will be described below, the solvent is used when the resin component (II) is produced.

In the resin composition of the present embodiment, the amount of the resin component (II) in the resin composition is preferably 5 to 100 mass %, and more preferably 50 to 100 mass %. In addition the amount of the solvent in the resin composition is preferably 0 to 5 mass %, and more preferably 0 to 0.5 mass %.

In the resin component (II), the amount of the polymerization component of the resin (b) with respect to 100 parts by mass of the polymerization component of the resin (a) is preferably 0 to 25.0 parts by mass, more preferably 0.35 to 15.0 parts by mass, and still more preferably 1.0 to 10.0 parts by mass.

In the resin component (II), the amount of the group represented by General Formula (11), (21) or (31) with respect to 100 parts by mass of the polymerization component of the resin (a) is preferably 0.02 to 5.0 parts by mass, more preferably 0.05 to 4.0 parts by mass, and still more preferably 0.37 to 3.20 parts by mass.

In the resin component (II), the amount of other polymerizable components with respect to 100 parts by mass of the polymerization component of the resin (a) is preferably 0 to 2,000 parts by mass, more preferably 0 to 100 parts by mass, and still more preferably 0 to 50 parts by mass.

In the resin composition, the amount of other non-polymerizable components with respect to 100 parts by mass of the polymerization component of the resin (a) is preferably 500 to 4,000 parts by mass, more preferably 800 to 2,000 parts by mass, and still more preferably 800 to 1,300 parts by mass.

The other non-polymerizable components can be arbitrarily selected according to purposes, and may be, for example, either a conductive component or a non-conductive component. A non-conductive component is more preferable.

For example, when the resin composition containing a conductive component is used, the resin sheet containing a conductive component and having stretchability and conductivity can be obtained. Such resin sheets are suitable, for example, for forming electrodes or wirings in stretchable devices.

On the other hand, the resin sheet obtained using the resin composition containing a non-conductive component (not containing a conductive component) is suitable for forming elements in stretchable devices. Here, examples of elements include a sealing layer for sealing a stretchable device and a layer for providing a wiring, an electrode, a metal-plated member, an electronic component or the like.

Regarding the conductive component, for example, a metal such as silver and copper is preferable as an exemplary example, and the metal is preferably in the form of particles (for example, silver particles, copper particles, and the like).

The resin composition of the first embodiment does not contain a curing agent (for example, a thermosetting agent), or even if it contains a curing agent, it is preferable that the amount thereof be small. Such a resin composition is advantageous in that the effect obtained by solidifying without performing a curing reaction is significant. This effect will be described in detail separately.

The weight average molecular weight (Mw) of the resin component (II) is preferably 61,000 to 250,000, more preferably 100,000 to 250,000, and still more preferably 150,000 to 250,000. Such a resin component (II) has better characteristics.

The resin component (II) has high solubility in a solvent due to its composition. Therefore, the resin composition containing the resin component (II) also has high solubility in a solvent.

A resin composition layer can be easily formed by printing such a resin composition having high solubility on an application target, by, for example, various printing methods. Then, the resin composition layer is solidified by drying without curing, and thus a layer (resin layer, resin sheet) similar to the resin sheet can be produced. Such a method is suitable for forming electrodes or wirings using the resin composition containing a conductive component.

A resin sheet having stretchability is formed using such a resin composition having high solubility, and a stretchable device constructed using the resin sheet has a great advantage that damage can be minimized during stretching thereof.

Examples of causes of damage to a general stretchable device during stretching in consideration of materials include (i) structural defects such as voids and interfacial peeling caused by contraction due to heat or a curing reaction, (ii) uneven hardness caused by uneven composition, and (iii) deterioration of materials over time caused by light emission, oxidation and the like.

Therefore, when structural defects such as voids, interfacial peeling, uneven composition, and deterioration of materials over time are minimized, it is possible to minimize damage to the stretchable device during stretching.

As processing of a stretchable substrate, molding by thermofusion and crosslinking by heating or a photocuring reaction are generally performed. However, due to the reasons (i) to (iii), in consideration up to fine processing, there is a concern of the reliability of the stretchable device becoming lower. On the other hand, for example, if there is a resin that can be molded only by applying and drying the resin composition that can correspond to the laminating method, it is expected that favorable results can be obtained.

As the resin for forming a stretchable element or an electrode, a urethane resin, a silicone resin, an acrylic resin, an epoxy resin, a polycarbonate, a polystyrene, a polyolefin or the like is used. In particular, the urethane resin is a stretchable material most often used for clothes and the like made of a stretch material because it has the best extensibility and strength. On the other hand, the disadvantage of the urethane resin is particularly (iii) deterioration over time, but if a curing reaction is not performed to form a crosslink, it is possible to minimize deterioration due to light and heat.

In view of the above viewpoint, a highly reliable stretch device can be realized using a urethane resin that can be molded only by applying and drying the resin composition. The resin composition containing the resin component (II) achieves such an object.

When a butyl carbitol acetate solution (BCA solution) containing the resin composition with a concentration of 15 mass % of the resin composition of the first embodiment is adjusted to a temperature of 25° C., and the viscosity (in this specification, it may be abbreviated as a “viscosity (10 rpm)”) of the butyl carbitol acetate solution is measured while stirring at a stirring speed of 10 rpm, the viscosity (10 rpm) is 0.07 to 22.35 Pas (70 to 22,350 cP). The resin composition having a viscosity (10 rpm) of 22.35 Pas or less is suitable for application to printing methods and is suitable for forming electrodes or wirings. Since the resin composition having a viscosity (10 rpm) of 0.07 Pas or more contains a resin having a high degree of polymerization, and is more favorably solidified by drying, it can be favorably handled.

The viscosity (10 rpm) may be, for example, 0.235 to 12.9 Pa·s, and may be 0.95 to 12.9 Pa·s. Such a resin composition is also suitable for preparing an electrode or a paste for wiring.

When the solution (BCA solution) is adjusted to a temperature of 25° C. and the viscosity (in this specification, it may be abbreviated as an a “viscosity (1 rpm)”) of the solution is measured while stirring at a stirring speed of 1 rpm, the viscosity (1 rpm) is preferably 0 to 110 Pa·s (0 to 110,000 cP). The resin composition having a viscosity (1 rpm) of 110 Pa·s or less can inhibit gelling while having a high viscosity, is suitable for application to printing methods, and is suitable for preparing an electrode or a paste for wiring.

The viscosity (10 rpm) and the viscosity (1 rpm) can be measured using a digital viscometer (BROOKFIELD viscometer HB DV-1 Prime, spindle: S21 type).

In the first embodiment, the value obtained by dividing the viscosity (1 rpm) by the viscosity (10 rpm) (in this specification, it may be abbreviated as a “viscosity ratio (1 rpm/10 rpm)”) is preferably 0 to 6, and more preferably 1.7 to 4.8. The resin composition having such a viscosity ratio (1 rpm/10 rpm) is suitable for preparing an electrode or a paste for wiring.

### “Method of Producing Resin Composition”

For example, the resin composition can be produced by preparing a raw material mixture in which the resin (a), the RAFT agent (that is, the RAFT agent (1), the RAFT agent (2) or the RAFT agent (3)), a polymerization initiator (in this specification, it may be referred to as a “polymerization initiator (c)”), a solvent, and as necessary, the resin (b), and as necessary, the other polymerizable components, and as necessary, the other non-polymerizable components are mixed, and performing a polymerization reaction in the raw material mixture to produce the resin component (II).

The raw material mixture is one of the resin compositions containing the resin (a), but in this specification, when “resin composition” is simply described, it indicates a resin composition which is a raw material for producing the resin sheet, which contains the resin component (II), rather than the raw material mixture before a polymerization reaction is performed.

The resin (a) contained in the raw material mixture may be of only one type or of two or more types.

In the raw material mixture, the amount of the resin (a) with respect to a total amount of the raw material mixture is preferably 9.6 to 30 mass %, and more preferably 11 to 15 mass %. When the amount is 9.6 mass % or more, the production of the resin sheet by drying and solidifying the resin composition becomes easier. When the amount is 30 mass % or less, it becomes easier to improve handling properties of the resin composition using the stretchability, the strength and the solvent.

The resin (b) contained in the raw material mixture may be of only one type or of two or more types.

When the resin (b) is used, in the raw material mixture, the amount of the resin (b) with respect of 100 parts by mass of the resin (a)+other polymerizable components may be, for example, 0.2 to 16 parts by mass, and is preferably 0.2 to 10 parts by mass, more preferably 0.2 to 5 parts by mass, and still more preferably 0.2 to 3 parts by mass. When the amount is 0.2 parts by mass or more, the water repellency of the resin composition is more apparently improved. When the amount is 10 parts by mass or less, excessive use of the resin (b) can be avoided, and for example, it is possible to prevent the resin composition from becoming cloudy and the uniformity of the resin composition from decreasing.

The RAFT agent (RAFT agents (1) to (3)) contained in the raw material mixture may be of only one type or of two or more types, but generally, only one type is sufficient.

In the raw material mixture, the amount of the RAFT agent with respect of 100 parts by mass of the resin (a)+other polymerizable components is preferably 0.03 to 5 parts by mass, more preferably 0.03 to 4.5 parts by mass, and still more preferably 0.03 to 4 parts by mass. When the amount is 0.03 parts by mass or more, the effect obtained using the RAFT agent can be obtained more significantly. When the amount is 5 parts by mass or less, excessive use of the RAFT agent can be avoided.

The polymerization initiator (c) may be a known initiator, and is not particularly limited.

Examples of polymerization initiators (c) include dimethyl 2,2′-azobis(2-methylpropionate) and azobisisobutyronitrile.

The polymerization initiator (c) contained in the raw material mixture may be of only one type or of two or more types, but generally, only one type is sufficient.

In the raw material mixture, the amount of the polymerization initiator (c) with respect of 100 parts by mass of the resin (a)+other polymerizable components is preferably 0.5 to 5 parts by mass, more preferably 0.6 to 4 parts by mass, and still more preferably 0.7 to 3 parts by mass. When the amount is 0.5 parts by mass or more, the polymerization reaction proceeds more smoothly. When the amount is 5 parts by mass or less, excessive use of the polymerization initiator (c) can be avoided.

The solvent is not particularly limited as long as it does not exhibit the reactivity with each of the above compounding components used when the raw material mixture is prepared or the polymerization reaction product, and a solvent having favorable solubility for each compounding component is preferable.

Examples of solvents include butyl carbitol acetate, methyl ethyl ketone (MEK), polyethylene glycol methyl ethyl acetate, and ethyl carbitol acetate.

The solvent contained in the raw material mixture may be of only one type or of two or more types.

In the raw material mixture, preferably, the raw material mixture contains a solvent so that the amount of 100 parts by mass of the resin (a)+other polymerizable components with respect to a total amount of the raw material mixture is 5 to 30 mass %. More preferably, the raw material mixture contains a solvent so that the amount of 100 parts by mass of the resin (a)+other polymerizable components with respect to a total amount of the raw material mixture is 10 to 25 mass %.

When the amount of the solvent used is within such a range, the resin component (II) having better characteristics can be obtained more smoothly.

The other polymerizable components contained in the raw material mixture may be of only one type or of two or more types.

When the other polymerizable components are used, in the raw material mixture, the amount of the other polymerizable components with respect to a amount of 100 parts by mass of the resin (a) is preferably 5 to 55 parts by mass, more preferably 10 to 50 parts by mass, and still more preferably 15 to 45 parts by mass. When the amount is 5 parts by mass or more, the effect obtained using the other polymerizable components can be obtained more significantly. When the amount is 55 parts by mass or less, the solubility of the resin composition in the solvent is further improved, and the stretchability of the resin sheet obtained using the resin composition is further improved.

The other non-polymerizable components contained in the raw material mixture may be of only one type or of two or more types.

The amount of the other non-polymerizable components in the raw material mixture can be arbitrarily set according to the type of the other non-polymerizable components.

For example, when the conductive component is used as the other non-polymerizable component, in the raw material mixture, the amount of the conductive component with respect of 100 parts by mass of the resin (a)+other polymerizable components is preferably 500 to 2,000 parts by mass, more preferably 800 to 1,600 parts by mass, and still more preferably 800 to 1,300 parts by mass. When the amount is 500 parts by mass or more, the conductivity of the resin sheet becomes higher. When the amount is 2,000 parts by mass or less, the effect obtained when the resin composition contains the resin component (IT) becomes stronger.

In the raw material mixture, the amount of the curing agent with respect of 100 parts by mass of the resin (a)+other polymerizable components is preferably 0 to 0.01 parts by mass, and particularly preferably 0 parts by mass, that is, the raw material mixture does not contain the curing agent. Such a resin composition is advantageous in that the effect obtained accordingly is significant because the curing reaction thereof is substantially not performed or not performed at all.

In the raw material mixture, a total amount of the resin (a), the RAFT agent, the polymerization initiator (c), the optionally used resin (b), other optionally used polymerizable components, and the optionally used conductive component with respect to a total amount of 100 parts by mass of the components other than the solvent in the raw material mixture is preferably 60 to 100 parts by mass, more preferably 90 to 100 parts by mass, and may be, for example, either 60 to 70 parts by mass or 99 to 100 parts by mass. When the amount is 60 parts by mass or more, the effects of the present disclosure can be obtained more significantly.

The polymerization reaction is preferably performed in an atmosphere of an inert gas such as nitrogen gas, helium gas, or argon gas.

The temperature (reaction temperature) at which a polymerization reaction is performed is preferably 70° C. to 110° C. and more preferably 80° C. to 100° C.

The polymerization reaction time (reaction time) may be appropriately adjusted according to the type of raw materials used and the reaction temperature, and may be, for example, 5 to 240 minutes.

In the present embodiment, when the polymerization reaction of the resin (a) is performed using the RAFT agent (1), (2) or (3), the polymerization reaction can stably proceed, and as a result, the resin component (II) is stably obtained so that the composition, the molecular weight distribution, the structure and the like of the resin component (II) are within a certain range. In particular, during the polymerization reaction, since the reaction rate is appropriately adjusted, the reaction rapidly proceeds, and thus the viscosity of the reaction solution rapidly increases, and in a procedure of forming a cross-linked structure, the problem of gelling is minimized, and a resin component (II) having a desired degree of polymerization and cross-linked state is stably obtained.

The same effect is obtained when the resin (b) is used.

As a method of performing radical polymerization, in addition to RAFT polymerization using an RAFT agent, atom transfer radical polymerization (ATRP) and nitroxide-mediated polymerization (NMP) are known, but the ATRP has a disadvantage that it is necessary to perform a polymerization reaction at a high concentration of a catalyst containing a transition metal, and the NMP has a disadvantage that it is difficult to control the polymerization reaction and its versatility is low. Due to these disadvantages, these methods are not suitable for producing the resin component (II) which is a desired component of the present disclosure.

On the other hand, in the present embodiment, when RAFT polymerization using the RAFT agent (1), (2) or (3) is selected, a resin component (II) having desired characteristics can be stably produced with high versatility.

In the present embodiment, the reaction solution obtained after the polymerization reaction may be directly used as the resin composition, and the result obtained by performing a known post-treatment on the obtained reaction solution may be used as the resin composition.

### “Resin Sheet”

In the first embodiment, the resin composition is solidified by drying to obtain a resin sheet.

Since the resin sheet contains the resin component (II) as a main component, it has favorable stretchability. When the resin (b) is used, the resin sheet also has appropriate water repellency, deterioration over time due to hydrolysis is minimized. The resin sheet having such characteristics is particularly suitable for forming various stretchable devices such as wearable devices.

That is, the laminated body having the resin sheet of the first embodiment is particularly suitable for use as a stretchable device.

The resin sheet can be formed only by solidifying by drying as described above without performing a curing reaction of the resin composition. Therefore, there are no problems associated with performing the curing reaction.

For example, in the photocuring reaction, it is very difficult to uniformly cure a substance that does not transmit ultraviolet light. For example, in a photocurable resin sheet, when ultraviolet light is emitted to a peripheral part of a mounted device or electronic component, because the transmission of ultraviolet light varies, different parts have different degrees of curing, and the resin sheet is easily damaged in parts having a low crosslink density. In addition, the non-crosslinked part is likely to deteriorate due to oxidation.

On the other hand, in the thermosetting reaction, a contraction difference is likely to occur in the resin sheet due to heat distribution during curing. When such a contraction difference occurs, different constituent materials such as a device and a sealing material are likely to peel off at their interfaces. In addition, if a part having a different degree of curing occurs in the resin sheet due to heat distribution, deterioration is likely to occur due to repeated stretching.

In addition, it is difficult for both the photocuring reaction and the thermosetting reaction to proceed uniformly in the resin sheet, and in this case, in the resin sheet, the composition and the degree of curing vary, and the cured resin sheet does not have desired stretchability and strength. Moreover, since a curing agent is contained, deterioration over time due to heat and light is likely to occur.

On the other hand, the resin sheet obtained by solidifying the resin composition of the first embodiment by drying does not have such a problem.

For example, the resin sheet can be produced by applying the resin composition to a desired part and solidifying it by drying without performing a curing reaction.

The resin composition can be applied by, for example, known methods using various coaters or wire bars or various printing methods including an ink jet printing method.

When the resin sheet is produced, the drying temperature of the resin composition is preferably 25° C. to 150° C., and more preferably 25° C. to 120° C. When the drying temperature is 25° C. or higher, the resin sheet can be produced more efficiently. When the drying temperature is 150° C. or lower, the drying temperature is prevented from becoming excessively high, deformation of the release sheet and damage to the resin sheet are unlikely to occur, and deterioration of the resin sheet is minimized.

When the resin sheet is produced, the drying time of the resin composition may be appropriately set according to the drying temperature, and is preferably 10 to 120 minutes, and more preferably 30 to 90 minutes. When the drying time is within such a range, a resin sheet having favorable characteristics can be efficiently produced.

The completion of solidification (formation of the resin sheet) of the resin composition by drying can be determined, for example, by the fact that no apparent change is observed in the mass of the resin composition subjected to drying.

In the first embodiment, when MEK is attached to the surface of the resin sheet, a contact angle with respect to MEK is measured in stages in which the time after attachment is 3 seconds and 13 seconds, the value obtained by dividing the contact angle in the stage in which the time after attachment is 3 seconds by the contact angle in the stage in which the time after attachment is 13 seconds (in this specification, it may be abbreviated as a “contact angle ratio (3 seconds/13 seconds)”) may be, for example, 0.94 to 2.03, and is preferably 0.94 to 1.83. The resin sheet having the contact angle ratio (3 seconds/13 seconds) in such a range contains a large amount of a resin component having a large molecular weight and has high solvent resistance.

As described above, the reason why the contact angle ratio (3 seconds/13 seconds) is defined rather than simply defining the contact angle with respect to MEK is that MEK is suitable as a solvent in the raw material mixture.

A solvent such as MEK has appropriate solubility, and is not only effective in minimizing the stretch, strength, and deterioration over time of the resin sheet, but also has favorable handling properties in production, and has a strong effect of minimizing deformation of the resin sheet due to the action of the solvent.

MEK is attached to the surface of the resin sheet, and the contact angle with respect to MEK in stages in which the time after attachment is 3 seconds and 13 seconds can be measured using a solid-liquid interface analyzing device.

In the first embodiment, MEK is attached to the surface of the resin sheet, and the contact angle with respect to MEK in the stage in which the time after attachment is 3 seconds is preferably an angle that satisfies the above contact angle ratio (3 seconds/13 seconds), and for example, is preferably 14° to 34°, and more preferably 15° to 34°.

In the first embodiment, MEK is attached to the surface of the resin sheet, and the contact angle with respect to MEK in the stage in which the time after attachment is 13 seconds is preferably an angle that satisfies the above contact angle ratio (3 seconds/13 seconds), and for example, is preferably 7° to 33°, and more preferably 8° to The amount of MEK attached to the resin sheet when the contact angle with respect to MEK is measured is not particularly limited as long as the contact angle with respect to MEK can be measured with high accuracy, and it is preferably 1 to 3 μL, and may be, for example, 2.2 μL.

### Second Embodiment

### “Resin Composition”

A resin composition of a second embodiment contains a resin component (in this specification, it may be referred to as a “resin component (I)”), and the resin component has a group represented by the following General Formula (11), (21) or (31), a urethane bond, and a siloxane bond, and the contact angle of a test resin sheet obtained by solidifying the resin composition by drying with respect to water is 77° to 116°.

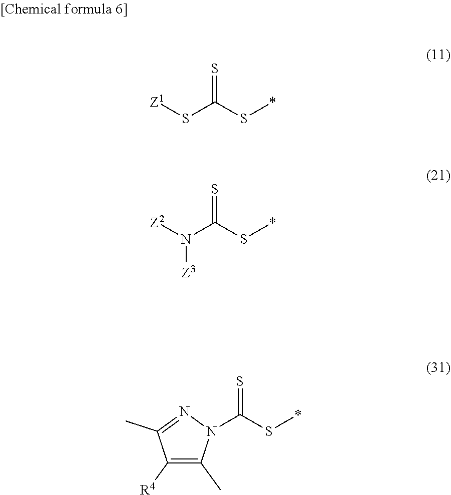

(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).

Since the resin component (I) contained in the resin composition of the second embodiment has a urethane bond, it has high flexibility.

In addition, since the resin component (I) has a siloxane bond, the resin composition has appropriate water repellency, and hydrolysis of the urethane bond of the resin component (I) is minimized.

In addition, the resin component (I) is obtained by performing a polymerization reaction using a resin having a urethane bond and a polymerizable unsaturated bond and a resin having a siloxane bond and a polymerizable unsaturated bond, and additionally an RAFT agent for performing reversible addition fragmentation chain transfer polymerization (in this specification, it may be abbreviated as “RAFT polymerization”) from which a group represented by General Formula (11), (21) or (31) is derived. When the polymerization reaction is performed in this manner, it is possible to prevent the resin during polymerization from gelling in a procedure of forming a cross-linked structure, and it is possible to obtain a resin component having a desired degree of polymerization and cross-linked state. That is, the resin component (I) having a group represented by General Formula (11), (21) or (31) has a small variation in terms of the degree of polymerization and cross-linked state. Here, a method of producing the resin component (I) for performing RAFT polymerization will be described in detail separately.

The resin having a urethane bond and a polymerizable unsaturated bond used for producing the resin component (I) is an oligomer, and may be referred to as a “resin (a)” in the second embodiment.

In addition, the resin having a siloxane bond and a polymerizable unsaturated bond used for producing the resin component (I) is an oligomer, and may be referred to as a “resin (b)” in the second embodiment.

The resin component (I) is a polymer produced by polymerizing the resin (a) and the resin (b) a their polymerizable unsaturated bonds.

The resin component (I) preferably has both a urethane bond and a siloxane bond in one molecule thereof

The resin (a) is not particularly limited as long as it has a urethane bond and a polymerizable unsaturated bond.

Specific examples of resins (a) include the same compounds as in the first embodiment as long as they have the same weight average molecular weight (Mw) as in the first embodiment.

The resin (b) is not particularly limited as long as it has a siloxane bond and a polymerizable unsaturated bond.

Specific examples of resins (b) include the same compounds as in the first embodiment as long as they have the same weight average molecular weight (Mw) as in the first embodiment.

In General Formula (11), Z¹ is an alkyl group.

The alkyl group for Z¹ may be linear, branched or cyclic, and is preferably linear or branched, and more preferably linear.

Specific examples of alkyl groups for Z¹ include the same alkyl groups as in the first embodiment, and preferable Z¹ is also the same as in the first embodiment.

In General Formula (21), Z² is an alkyl group.

Specific examples of alkyl groups for Z² include the same alkyl groups as in the first embodiment, and preferable Z² is also the same as in the first embodiment.

In General Formula (21), Z³ is an aryl group.

Specific examples of aryl groups for Z³ include the same aryl groups as in the first embodiment, and preferable Z³ is also the same as in the first embodiment.

In General Formula (31), R⁴ is a hydrogen atom or a halogen atom.

Specific examples of halogen atoms for R⁴ include the same halogen atoms as in the first embodiment, and preferable R⁴ is also the same as in the first embodiment.

In General Formula (11), (21) or (31), the bond with the symbol * is formed with the bonding destination of the group represented by General Formula (11), (21) or (31), that is, an end part in the polymer of the resin (a) and the resin (b).

Examples of RAFT agents from which a group represented by General Formula (11) is derived include compounds represented by General Formula (1) (in this specification, it may be abbreviated as an “RAFT agent (1)”), which are the same as those in the first embodiment.

When the RAFT agent (1) is used, according to a polymerization reaction, a group represented by R¹ in General Formula (1) is bonded to an end part of the polymer of the resin (a) and the resin (b) to which a group represented by General Formula (11) is not bonded.

Examples of RAFT agents from which a group represented by General Formula (21) is derived include compounds represented by General Formula (2) (in this specification, it may be abbreviated as an “RAFT agent (2)”), which are the same as those in the first embodiment.

When the RAFT agent (2) is used, according to a polymerization reaction, a group represented by R² in General Formula (2) is bonded to an end part of the polymer of the resin (a) and the resin (b) to which a group represented by General Formula (21) is not bonded.

Examples of RAFT agents from which a group represented by General Formula (31) is derived include compounds represented by General Formula (3) (in this specification, it may be abbreviated as an “RAFT agent (3)”), which are the same as those in the first embodiment.

When the RAFT agent (3) is used, according to a polymerization reaction, a group represented by R³ in General Formula (3) is bonded to an end part of the polymer of the resin (a) and the resin (b) to which a group represented by General Formula (31) is not bonded.

When the resin component (I) is produced, the resin (a), the resin (b), and other polymerizable components not corresponding to these may be used.

Regarding the other polymerizable components, for example, a monomer or oligomer having a polymerizable unsaturated bond is preferable as an exemplary example.

Regarding the other polymerizable components, more specifically, the same compounds as in the first embodiment are preferable as exemplary examples.

Regarding the resin composition of the second embodiment, for example, those containing a resin component (I) and a solvent are preferable as exemplary examples, and those additionally containing other non-polymerizable components that do not correspond to these as necessary are preferable as exemplary examples.

As will be described below, the solvent is used when the resin component (I) is produced.

In the resin composition of the second embodiment, the amount of the resin component (I) in the resin composition is preferably 5 to 100 mass %, and more preferably 50 to 100 mass %. In addition, the amount of the solvent in the resin composition is preferably 0 to 5 mass %, and more preferably 0 to 0.5 mass %.

In the resin component (I), the amount of the polymerization component of the resin (b) with respect to 100 parts by mass of the polymerization component of the resin (a) is preferably 0 to 25.0 parts by mass, more preferably 0.35 to 15.0 parts by mass, and still more preferably 1.0 to 10.0 parts by mass.

In the resin component (I), the amount of the group represented by General Formula (11), (21) or (31) with respect to 100 parts by mass of the polymerization component of the resin (a) is preferably 0.02 to 5.0 parts by mass, more preferably 0.05 to 4.0 parts by mass, and still more preferably 0.37 to 3.20 parts by mass.

In the resin component (I), the amount of other polymerizable components with respect to 100 parts by mass of the polymerization component of the resin (a) is preferably 0 to 2,000 parts by mass, more preferably 0 to 100 parts by mass, and still more preferably 0 to 50 parts by mass.

In the resin composition, the amount of other non-polymerizable components with respect to 100 parts by mass of the polymerization component of the resin (a) is preferably 500 to 4,000 parts by mass, more preferably 800 to 2,000 parts by mass, and still more preferably 800 to 1,300 parts by mass.

The other non-polymerizable components can be arbitrarily selected according to purposes, and may be either a conductive component or a non-conductive component, which are the same as that in the first embodiment. A non-conductive component is more preferable.

As in the first embodiment, the resin composition of the second embodiment does not contain a curing agent (for example, a thermosetting agent), or even if it contains a curing agent, it is preferable that the amount thereof be small Such a resin composition is advantageous in that the effect obtained by solidifying without performing a curing reaction is significant.

The contact angle of the test resin sheet obtained by solidifying the resin composition of the second embodiment by drying with respect to water is 77° to 116°. When the contact angle with respect to water is 77° or more, the test resin sheet has a strong effect of minimizing hydrolysis of the urethane bond in the resin component (I). When the contact angle with respect to water is 116° or less, the test resin sheet has high flexibility (stretchability).

As described above, the test resin sheet that defines the contact angle with respect to water is produced by applying the resin composition to a desired part and solidifying it by drying without performing a curing reaction, and the drying temperature of the resin composition in this case is set to 90° C., and in the stage, no apparent change is observed in the mass of the resin composition by drying. In order to produce such a test resin sheet, the drying time may be about 15 minutes or more.

In the second embodiment, water is attached to the surface of the test resin sheet, and the contact angle with respect to water is preferably 77° to 116° while the time after attachment is 3 to 13 seconds. An effect of minimizing hydrolysis of the urethane bond in the resin component (I) and an effect of improving flexibility (stretchability) of the test resin sheet are more significant with such a test resin sheet.

The contact angle of the test resin sheet with respect to water may be 93° to 116.5°.

In the second embodiment, water is attached to the surface of the test resin sheet, and the contact angle with respect to water in the stage in which the time after attachment is 3 seconds is preferably 93° to 116.5°. An effect of minimizing hydrolysis of the urethane bond in the resin component (I) and an effect of improving flexibility (stretchability) of the test resin sheet are more significant with such a test resin sheet.

The amount of water attached to the test resin sheet when the contact angle with respect to water is measured is not particularly limited as long as the contact angle with respect to water can be measured with high accuracy, and is preferably 1 to 3 μL.

The contact angle of the test resin sheet with respect to water can be measured using a solid-liquid interface analyzing device.

The weight average molecular weight (Mw) of the resin component (I) is preferably 52,000 to 250,000, more preferably 61,000 to 250,000, and still more preferably 100,000 to 250,000. Such a resin component (I) has better characteristics.

### “Method of Producing Resin Composition”

For example, the resin composition can be produced by preparing a raw material mixture in which the resin (a), the resin (b), the RAFT agent (that is, the RAFT agent (1), the RAFT agent (2) or the RAFT agent (3)), a polymerization initiator (in this specification, it may be referred to as a “polymerization initiator (c)”), a solvent, and as necessary, the other polymerizable components, and as necessary, the other non-polymerizable components are mixed, and performing a polymerization reaction in the raw material mixture to produce the resin component (I).

The raw material mixture is one of the resin composition containing the resin (a) and the resin (b), but in this specification, when “resin composition” is simply described, it indicates a resin composition which is a raw material for producing the resin sheet, which contains the resin component (I), rather than the raw material mixture before a polymerization reaction is performed.

The resin (a) contained in the raw material mixture may be of only one type or of two or more types.

In the raw material mixture, the amount of the resin (a) with respect to a total amount of the raw material mixture is preferably 9.6 to 30 mass %, and more preferably 11 to 25 mass %. When the amount is 9.6 mass % or more, the production of the resin sheet by drying and solidifying the resin composition becomes easier. When the amount is 30 mass % or less, it becomes easier to improve handling properties of the resin composition using a solvent.

The resin (b) contained in the raw material mixture may be of only one type or of two or more types.

In the raw material mixture, the amount of the resin (b) with respect of 100 parts by mass of the resin (a)+other polymerizable components is preferably 0.2 to 25 parts by mass, more preferably 0.2 to 20 parts by mass, and still more preferably 0.2 to 17 parts by mass. When the amount is 0.2 parts by mass or more, the water repellency of the resin composition is improved more apparently. When the amount is 25 parts by mass or less, excessive use of the resin (b) can be avoided, and for example, it is possible to prevent the resin composition from becoming harder than necessary and the uniformity of the resin composition from decreasing.

The RAFT agent (RAFT agents (1) to (3)) contained in the raw material mixture may be of only one type or of two or more types, but generally, only one type is sufficient.

In the raw material mixture, the amount of the RAFT agent with respect of 100 parts by mass of the resin (a)+other polymerizable components is preferably 0.03 to 5 parts by mass, more preferably 0.03 to 4.5 parts by mass, and still more preferably 0.03 to 4 parts by mass. When the amount is 0.03 parts by mass or more, the effect obtained using the RAFT agent can be obtained more significantly. When the amount is 5 parts by mass or less, excessive use of the RAFT agent can be avoided.

The polymerization initiator (c) may be a known initiator, and is not particularly limited.

Examples of polymerization initiators (c) include dimethyl 2,2′-azobis(2-methylpropionate) and azobisisobutyronitrile.

The polymerization initiator (c) contained in the raw material mixture may be of only one type or of two or more types, but generally, only one type is sufficient.

In the raw material mixture, the amount of the polymerization initiator (c) with respect of 100 parts by mass of the resin (a)+other polymerizable components is preferably 0.5 to 5 parts by mass, more preferably 0.7 to 4 parts by mass, and still more preferably 0.9 to 3 parts by mass. When the amount is 0.5 parts by mass or more, the polymerization reaction proceeds more smoothly. When the amount is 5 parts by mass or less, excessive use of the polymerization initiator (c) can be avoided.

Regarding the solvent contained in the raw material mixture, it is preferable to use the same solvent as in the first embodiment in the same amount.

The other polymerizable components contained in the raw material mixture may be of only one type or of two or more types.

When the other polymerizable components are used, in the raw material mixture, the amount of the other polymerizable components with respect to a amount of 100 parts by mass of the resin (a) is preferably 5 to 55 parts by mass, more preferably 10 to 50 parts by mass, and still more preferably 15 to 45 parts by mass. When the amount is 5 parts by mass or more, the effect obtained using the other polymerizable components can be obtained more significantly. When the amount is 55 parts by mass or less, the stretchability of the resin sheet obtained using the resin composition is further improved, and deterioration of the resin sheet over time is further minimized.

The other non-polymerizable components contained in the raw material mixture may be of only one type or of two or more types.

In the raw material mixture, the amount of the curing agent with respect of 100 parts by mass of the resin (a)+other polymerizable components is preferably 0 to 0.01 parts by mass, and particularly preferably 0 parts by mass, that is, the raw material mixture does not contain the curing agent. Such a resin composition is advantageous in that the effect obtained accordingly is significant because the curing reaction thereof is substantially not performed or not performed at all.

In the raw material mixture, the total amount of the resin (a), the resin (b), the RAFT agent, the polymerization initiator (c), and the other optionally used polymerizable components with respect to the total amount of 100 parts by mass of components other than the solvent in the raw material mixture is preferably 90 to 100 parts by mass, and more preferably 95 to 100 parts by mass, and may be, for example, either 97 to 100 parts by mass or 99 to 100 parts by mass. When the amount is 90 parts by mass or more, the effects of the present disclosure can be obtained more significantly.

The polymerization reaction is preferably performed in the same inert gas atmosphere and under the same reaction temperature and reaction time conditions as in the first embodiment.

In the second embodiment, when the polymerization reaction of the resin (a) and the resin (b) is performed using the RAFT agent (1), (2) or (3), the polymerization reaction can stably proceed, and as a result, the resin component (I) is stably obtained so that the composition, the molecular weight distribution, the structure and the like of the resin component (I) are within a certain range. In particular, during the polymerization reaction, since the reaction rate is appropriately adjusted, the reaction rapidly proceeds, and thus the viscosity of the reaction solution rapidly increases, and in a procedure of forming a cross-linked structure, the problem of gelling is minimized, and a resin component (I) having a desired degree of polymerization and cross-linked state is stably obtained.

As a method of performing radical polymerization, in addition to RAFT polymerization using a RAFT agent, atom transfer radical polymerization (ATRP) and nitroxide-mediated polymerization (NMP) are known, but for the same reason as in the first embodiment, these polymerization reactions are not suitable for producing the resin component (I) which is a desired component of the present disclosure.

On the other hand, in the second embodiment, when RAFT polymerization using RAFT agent (1), (2) or (3) is selected, a resin component (I) having desired characteristics can be stably produced with high versatility.

In the second embodiment, the reaction solution obtained after the polymerization reaction may be directly used as the resin composition, and the result obtained by performing a known post-treatment on the obtained reaction solution may be used as the resin composition.

### “Resin Sheet”

In the second embodiment, the resin composition is solidified by drying to obtain a resin sheet.

Since the resin sheet contains the resin component (I) as a main component, it has favorable stretchability and also has appropriate water repellency so that deterioration over time due to hydrolysis is minimized. The resin sheet having such characteristics is particularly suitable for forming various stretchable devices such as wearable devices.

For example, the resin sheet is suitable for forming elements in stretchable devices. Here, examples of elements include a sealing layer for sealing a stretchable device and a layer for providing a wiring, an electrode, a metal-plated member, an electronic component or the like.

That is, the laminated body having the resin sheet of the second embodiment is particularly suitable for use as a stretchable device.

The resin sheet can be formed only by solidifying by drying as described above without performing a curing reaction of the resin composition. Therefore, there are no problems associated with performing the curing reaction.

As described in the first embodiment, the resin sheet obtained by the photocuring reaction or the thermosetting reaction is likely to deteriorate, and does not have the desired stretchability and strength.

On the other hand, the resin sheet obtained by solidifying the resin composition of the second embodiment by drying does not have such a problem.

For example, the resin sheet can be produced by applying the resin composition to a desired part and solidifying it by drying without performing a curing reaction.

For example, the resin composition can be applied by known methods using various coaters or wire bars.

When the resin sheet is produced, the drying temperature of the resin composition is preferably 25° C. to 150° C., and may be, for example, 70° C. to 120° C. When the drying temperature is 25° C. or higher, the resin sheet can be produced more efficiently. When the drying temperature is 150° C. or lower, the drying temperature is prevented from becoming excessively high, deformation of the release sheet and damage to the resin sheet are unlikely to occur, and deterioration of the resin sheet is minimized.

When the resin sheet is produced, the drying time of the resin composition may be appropriately set according to the drying temperature, and is preferably 10 to 120 minutes, and more preferably 10 to 90 minutes. When the drying time is within such a range, a resin sheet having favorable characteristics can be efficiently produced.

The completion of solidification (formation of the resin sheet) of the resin composition by drying can be determined, for example, by the fact that no apparent change is observed in the mass of the resin composition subjected to drying.

The test resin sheet of the second embodiment described above is an example of the resin sheet forming the laminated body of the second embodiment.

The resin sheet forming the laminated body of the second embodiment exhibits the contact angle with respect to water as in the case of the test resin sheet of the second embodiment.

### “Laminated Body”

The laminated body of the first embodiment or the second embodiment includes the resin sheet of the first embodiment or the second embodiment obtained by solidifying the resin composition by drying.

The resin sheet included in the laminated body may have only one layer (sheet) or may have two or more layers (sheets). When the laminated body includes two or more layers of resin sheets, these two or more layers of resin sheets may be the same as or different from each other.

In this specification, not only in the case of the resin sheet, “two or more layers may be the same as or different from each other” means that “all layers may be the same, all layers may be different, or only some layers may be the same,” and also “two or more layers are different from each other” means that “at least one of the constituent material and the thickness of a layer is different from that of another.”

For example, regarding the laminated body including two or more layers of resin sheets, those including the resin sheet in which a wiring, an electrode, a metal-plated member, an electronic component or the like is provided and the resin sheet in which the above component is not provided and which functions as a sealing layer is preferable as an exemplary example. However, this is an example of the laminated body.

The thickness of the resin sheet in one layer is preferably 1 to 2,000 μm, and may be, for example, 5 to 1,000 μm. When the thickness of the resin sheet is 1 μm or more, the strength of the resin sheet is further improved. When the thickness of the resin sheet is 2,000 μm or less, the resin sheet can be used in a state in which the stress during bending is low.

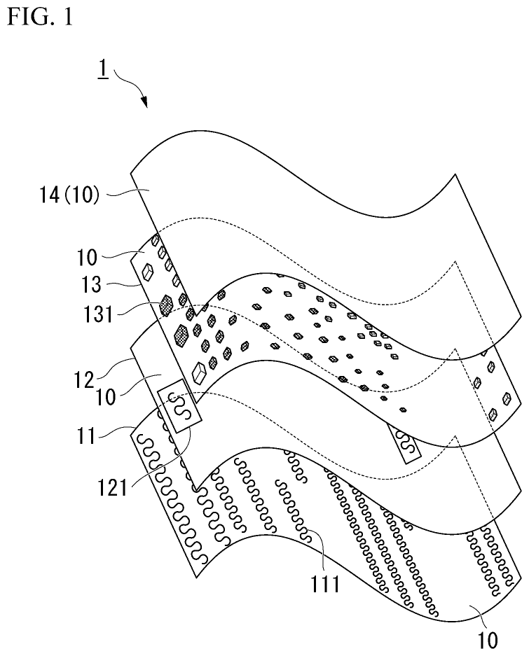

FIG. 1 is a schematic diagram showing an example of the laminated body of the first embodiment or the second embodiment in a disassembled manner.

Here, in the drawings used in the following description, in order to facilitate understanding of features of the present disclosure, feature parts are enlarged for convenience of illustration in some cases, and dimensional proportions and the like of components are not necessarily the same as those of actual components.

A laminated body 1 shown here has a configuration in which a first sheet 11, a second sheet 12, a third sheet 13, and a fourth sheet 14 are laminated in that order in the thickness direction thereof. In this specification, these four layers (sheets) of resin sheets may be collectively referred to as “first sheet 11 to fourth sheet 14.”

The first sheet 11 has a configuration in which an electrode 111 is provided together with a wiring on the surface of a resin sheet 10 on the side of the second sheet 12.

The second sheet 12 has a configuration in which a copper-plated member 121 is embedded or attached into the resin sheet 10. In addition, in the second sheet 12, vias or connection parts for connecting to wirings of other sheets are provided.

The third sheet 13 has a configuration in which an electronic component 131 is embedded or mounted in the resin sheet 10. In addition, in the third sheet 13, vias or connection parts for connecting to wirings of other sheets are provided.

The fourth sheet 14 is composed of only the resin sheet 10.

All of the resin sheets 10 in the first sheet 11 to the fourth sheet 14 may be the resin sheet of the first embodiment or the second embodiment or may be known stretchable sheets.

The wiring and the electrode 111 provided on the first sheet 11 may be known components, but are preferably the resin sheet containing the above conductive component of the first embodiment or the second embodiment.

In the laminated body 1, any one of the first sheet 11 to the fourth sheet 14, and the wiring and the electrode 111 may be the above resin sheet of the first embodiment or the second embodiment, and at least, the wiring and the electrode 111 are preferably the above resin sheet of the first embodiment or the second embodiment.

When the first sheet 11 to the fourth sheet 14 are laminated, the wiring and the electrode 111 on the first sheet 11 come in contact with the copper-plated member 121 in the second sheet 12, and the copper-plated member 121 comes into contact with the electronic component 131 in the third sheet 13. The fourth sheet 14 is provided on the first sheet 11, the second sheet 12 and the third sheet 13 so that the wiring, the electrode 111, the copper-plated member 121, and the electronic component 131 are not exposed, and functions as a sealing layer.

The laminated body 1 can be used as a stretchable device such as a wearable device, and the copper-plated member 121 and the electronic component 131 may be known in the art.

The laminated body 1 can be produced by laminating the first sheet 11, the second sheet 12, the third sheet 13, and the fourth sheet 14 so that they are disposed in that order.

The lamination order of these sheets when the laminated body 1 is produced is not particularly limited.

For example, the first sheet 11 can be produced by adhering a conductive composition (for example, the resin composition of the first embodiment or the second embodiment) for forming the wiring and the electrode 111 to one surface of the resin sheet 10 by a printing method, and drying it to form a conductive layer. When the resin sheet 10 is the resin sheet of the first embodiment or the second embodiment, it can be produced by the above production method.

For example, the second sheet 12 can be produced by disposing the copper-plated member 121 on the surface of the first sheet 11 on which the wiring and the electrode 111 are formed, and in this state, applying the composition for forming the second sheet 12 to the surface of the first sheet 11 on which the wiring and the electrode 111 are formed, and solidifying it. In this case, the copper-plated member 121 penetrates through the second sheet 12. When the composition for forming the second sheet 12 is the resin composition of the first embodiment or the second embodiment, the second sheet 12 can be produced by solidifying it by drying without curing it.

In addition, the second sheet 12 can also be produced by applying the composition to the surface of the first sheet 11 on which the wiring and the electrode 111 are formed and attaching the copper-plated member 121 to the product obtained by solidifying the composition.

For example, the third sheet 13 can be produced by disposing the electronic component 131 on the surface of the second sheet 12 on the side opposite to the first sheet 11, and in this state, applying the composition for forming the third sheet 13 to the surface of the second sheet 12 on the side opposite to the first sheet 11 (that is, the surface on which the electronic component 131 is disposed), and solidifying it. In this case, the electronic component 131 penetrates through the third sheet 13. When the composition for forming the third sheet 13 is the resin composition of the first embodiment or the second embodiment, the third sheet 13 can be produced by solidifying it by drying without curing it.

The fourth sheet 14 can be produced by applying the composition for forming the fourth sheet 14 to the surface of the third sheet 13 on the side opposite to the second sheet 12, and solidifying it. When the composition for forming the fourth sheet 14 is the resin composition of the first embodiment or the second embodiment, the fourth sheet 14 can be produced by solidifying it by drying without curing it.

Here, an example of the method of producing the laminated body 1 is shown here.

The laminated body of the first embodiment or the second embodiment is not limited to that shown in FIG. 1, and a part of the configuration may be changed, deleted or added without departing from the spirit of the present disclosure.

For example, although the sheet forming the laminated body has four layers in the laminated body 1, it may have one layer or a plurality of layers of a number other than four, that is, it can have one layer or two or more layers. The number of sheets in the laminated body can be arbitrarily set according to purposes of the laminated body. However, when the sheet is one layer, the laminated body has layers other than the sheet.

In addition, the sheet forming the laminated body includes a wiring, an electrode, a copper-plated member or an electronic component in the laminated body 1, but it may have other configurations.

Preferable laminated bodies of the first embodiment or the second embodiment include those in which another sheet (another layer) is additionally provided in addition to the resin sheet formed using the above resin composition of the first embodiment or the second embodiment.

Examples of other layers include a substrate layer containing a resin.

The substrate layer can be arbitrarily selected according to purposes of the laminated body, and may be a known layer and is not particularly limited.

As the substrate layer, for example, an adhesive layer for attaching a laminated body to an object to be used; and a release sheet which is attached to one surface or both surfaces of a laminated body and thus protects the laminated body during storage, and can be easily peeled off from the laminated body when the laminated body is used, is preferable as an exemplary example. However, these are examples of the substrate layer.

The thickness of the substrate layer is not particularly limited, and generally, preferably 10 to 2,000 μm and more preferably 20 to 1,000 μm. When the thickness of the substrate layer is 10 μm or more, the strength of the substrate layer is further improved. When the thickness of the substrate layer is 2,000 μm or less, it is possible to produce the substrate layer more easily.

Regarding the laminated body having the substrate layer, for example, the laminated body 1 shown in FIG. 1 in which an additional substrate layer is provided on the exposed surface of the first sheet 11 or the exposed surface of the fourth sheet 14 is preferable as an exemplary example. However, this is an example of the laminated body having a substrate layer.

### EXAMPLES

Hereinafter, the present disclosure will be described in more detail with reference to specific examples. However, the present disclosure is not limited to the following examples.

### Test Example 1

Raw materials used for producing the resin composition are shown below.

### Resin (a)

(a)-1: urethane acrylate oligomer (product name: UN-5500, commercially available from Negami Chemical Industrial Co., Ltd.)

### Resin (b)

(b)-1: methacrylate-modified polydimethylsiloxane having one end modified with a methacryloyl group (product name: Silaplane (registered trademark) FM-0721, commercially available from JNC)

### Polymerization Initiator (c)

(c)-1: dimethyl 2,2′-azobis(2-methylpropionate), azo polymerization initiator (product name: V601, commercially available from FUJIFILM Wako Pure Chemical Corporation)

### RAFT Agent

(1)-1: RAFT agent represented by the following Formula (1)-1 (commercially available from FUJIFILM Wako Pure Chemical Corporation)
(3)-1: RAFT agent represented by the following Formula (3)-1 (commercially available from FUJIFILM Wako Pure Chemical Corporation)

### Other Polymerizable Component

MMA: methyl methacrylate

### Solvent

BCA: butyl carbitol acetate

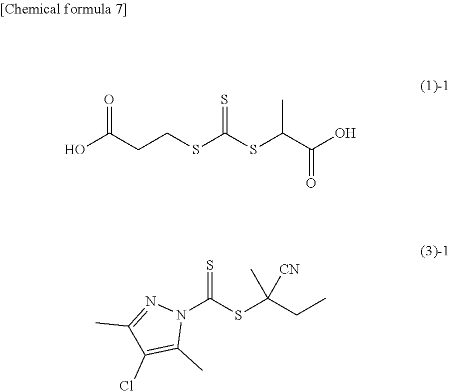 [SMILES: CC(SC(=S)SCCC(=O)O)C(=O)O ; CCC(C)(C#N)SC(=S)n1nc(C)c(Cl)c1C]

### Example 1-1

### <Production of Resin Composition>

A resin (a)-1 (100 parts by mass), a polymerization initiator (c)-1 (0.8 parts by mass), an RAFT agent (1)-1 (0.245 parts by mass), and BCA were weighed out in a flask and mixed at room temperature using a stirrer, and thereby a raw material mixture was obtained.

In the present disclosure, the formulation amounts of the resin (b), the polymerization initiator (c), and the RAFT agent with respect to 100 parts by mass of the resin (a)+other polymerizable components were determined. However, since no other polymerizable components were used in Example 1, the formulation amounts of the resin (b), the polymerization initiator (c), and the RAFT agent with respect to 100 parts by mass of the resin (a) were determined.

In addition, the solvent BCA was mixed so that 100 parts by mass of the resin (a) was 15 mass % of the raw material mixture.

Next, the inside of the closed flask was vacuum-deaerated.

Next, in a nitrogen atmosphere, using an oil bath, the raw material mixture was dissolved, the temperature was continuously raised with stirring, a polymerization reaction was caused at 90° C. for 20 minutes, and thus a resin component (II) was produced and also a resin composition containing the resin component (II) was produced.

### <Evaluation of Resin Composition>

### (Measurement of Weight Average Molecular Weight of Resin Component (II))

Three columns for GPC (product name: Shodex (registered trademark) LF-404, commercially available from Showa Denko K.K.) were connected in series, using a molecular weight measuring device (product name: Shodex (registered trademark) GPC-104, commercially available from Showa Denko K.K.), the temperature of the columns for GPC was set to 40° C., and the weight average molecular weight (Mw) of the resin component (II) obtained above was measured using tetrahydrofuran (THF) as a mobile phase. The weight average molecular weight was calculated using a calibration curve created in advance. The results are shown in Table 3.

(Measurement of Viscosity of Resin Composition, and Calculation of Viscosity Ratio (1 rpm/10 rpm))

The resin composition obtained above was dissolved in butyl carbitol acetate (BCA) to prepare a butyl carbitol acetate solution (BCA solution) containing the resin composition with a concentration of 15 mass % of the resin composition.

Next, using a digital viscometer (BROOKFIELD viscometer HB DV-1 Prime, spindle: S21 type), for a measuring cylinder, in an atmosphere in which cooling water at a temperature of 25° C. was circulated, the BCA solution obtained above was stirred at a stirring speed of 10 rpm for 5 minutes, and then left for 5 minutes, and the viscosity (viscosity (1 rpm)) was then measured with stirring at a stirring speed of 1 rpm. In addition, after being left for 1 minute, the viscosity (viscosity (10 rpm)) was measured with stirring at a stirring speed of 10 rpm. Then, the viscosity ratio (1 rpm/10 rpm) was calculated. The results are shown in Table 2.

### <Production of Resin Sheet>

Using a spray coater, the resin composition obtained above was applied onto a release film and dried at 115° C. for 60 minutes, and thus a resin sheet (test resin sheet with a thickness of 3 μm) was produced without performing a curing reaction.

In addition, a resin sheet (test resin sheet with a thickness of 80 μm) was produced by the same method as above except that the amount of the resin composition applied was changed.

### <Evaluation of Resin Sheet>

(Measurement of Contact Angle with Respect to MEK, and Calculation of Contact Angle Ratio (3 Seconds/13 Seconds))

Using a solid-liquid interface analyzing device (product name: DropMaster500, commercially available from Kyowa Interface Science Co., Ltd.), and additionally, using a syringe set 22G with a needle coated with polytetrafluoroethylene, in an air atmosphere, special grade MEK (2.2 μL) was attached to the surface of the resin sheet obtained above (with a thickness of 3 μm), the contact angle in stages in which the time after attachment was 3 seconds and 13 seconds was measured in a 22G mode, and the contact angle ratio (3 seconds/13 seconds) was calculated. The results are shown in Table 2.

The reason why the value of the contact angle changed after 3 seconds to 13 seconds was that MEK dissolved the resin film. In addition, a small amount of MEK volatilized between 3 seconds and 13 seconds also had some influence on the change in the value.

(Measurement of Contact Angle with Respect to Water)

Using a solid-liquid interface analyzing device (product name: DropMaster500, commercially available from Kyowa Interface Science Co., Ltd.), and additionally, using a syringe set 22G with a needle coated with polytetrafluoroethylene, pure water (2 μL) was attached to the surface of the resin sheet obtained above, and the contact angle in stages in which the time after attachment was 3 seconds, 8 seconds and 13 seconds was measured in a 22G mode. The results are shown in Table 3.

### (Evaluation of Uniformity of Resin Sheet)

The uniformity of the thickness was determined by observing the resin sheet having a thickness of 3 μm obtained above using a digital thickness measuring instrument and a digital microscope. The results are shown in Table 2.

In addition, the resin sheet having a thickness of 80 μm obtained above was visually observed to determine its color and transparency. The results are shown in Table 2.

### <Production and Evaluation of Resin Composition and Production and Evaluation of Resin Sheet>

### Examples 1-2 to 1-13

Resin compositions were produced and evaluated and resin sheets were produced and evaluated by the same methods as in Example 1-1 except that one or both of the type and the formulation amounts of compounding components of the raw material mixture for obtaining the resin composition or the polymerization reaction time was changed as shown in Table 1. The results are shown in Table 2.

In Table 1, “-” in the column of “compounding component (parts by mass) of raw material mixture” indicates that the component is not added. In addition, regarding the “solvent,” the formulation amount thereof is not described.

In Examples 1-2 to 1-13, with respect to 100 parts by mass of the resin (a)+other polymerizable components, the resin (b), the polymerization initiator (c), and the RAFT agent in formulation amounts shown in Table 1 were mixed.

Here, in Examples 1-10 and 1-11, the resin (a)+other polymerizable components=140 parts by mass was shown, but this was converted into 100 parts by mass, and the resin (b), the polymerization initiator (c), and the RAFT agent in the formulation amounts shown in Table 1 were mixed.

In addition, in Examples 1-2 to 1-13, the solvent BCA was mixed so that 100 parts by mass of the resin (a)+other polymerizable components was 15 mass % of the raw material mixture.

TABLE 1

| | Compounding components of raw material mixture (parts by mass) | | | | | | Polymerization | |
|---|---|---|---|---|---|---|---|---|
| | | | | | Other | | reaction | |
| | Resin | Resin | Polymerization | RAFT | polymerizable | | Temperature | Time |
| | (a) | (b) | initiator (c) | agent | component | Solvent | (° C.) | (min) |
| Example | (a)-1 | — | (c)-1 (0.8) | (1)-1 | — | BCA | 90 | 20 |
| 1-1 | (100) | | | (0.245) | | | | |
| Example | (a)-1 | — | (c)-1 (0.8) | (3)-1 | — | BCA | 90 | 20 |
| 1-2 | (100) | | | (0.263) | | | | |
| Example | (a)-1 | — | (c)-1 (0.8) | (1)-1 | — | BCA | 90 | 15 |
| 1-3 | (100) | | | (0.05) | | | | |
| Example | (a)-1 | — | (c)-1 (0.8) | (3)-1 | — | BCA | 90 | 15 |
| 1-4 | (100) | | | (0.05) | | | | |
| Example | (a)-1 | — | (c)-1 (0.8) | (1)-1 | — | BCA | 90 | 15 |
| 1-5 | (100) | | | (0.1) | | | | |
| Example | (a)-1 | (b)-1 | (c)-1 (0.8) | (1)-1 | — | BCA | 90 | 20 |
| 1-6 | (100) | (1.5) | | (0.245) | | | | |
| Example | (a)-1 | (b)-1 | (c)-1 (0.8) | (3)-1 | — | BCA | 90 | 60 |
| 1-7 | (100) | (1.5) | | (0.263) | | | | |
| Example | (a)-1 | (b)-1 | (c)-1 (0.8) | (1)-1 | — | BCA | 90 | 60 |
| 1-8 | (100) | (15) | | (0.245) | | | | |
| Example | (a)-1 | (b)-1 | (c)-1 (0.8) | (3)-1 | — | BCA | 90 | 60 |
| 1-9 | (100) | (15) | | (0.263) | | | | |
| Example | (a)-1 | | (c)-1 (0.8) | (1)-1 | MMA (40) | BCA | 90 | 60 |
| 1-10 | (100) | | | (0.245) | | | | |
| Example | (a)-1 | | (c)-1 (0.8) | (3)-1 | MMA (40) | BCA | 90 | 60 |
| 1-11 | (100) | | | (0.263) | | | | |
| Example | (a)-1 | | (c)-1 (2.4) | (1)-1 | — | BCA | 90 | 180 |
| 1-12 | (100) | | | (3.682) | | | | |
| Example | (a)-1 | | (c)-1 (2.4) | (3)-1 | — | BCA | 90 | 180 |
| 1-13 | (100) | | | (3.947) | | | | |

TABLE 2

| | Evaluation results | | | | | | | |
|---|---|---|---|---|---|---|---|---|
| | | | | Contact angle (° C.) | | Contact | | |
| | Viscosity | | Viscosity | of resin sheet with | | angle | | |
| | (Pa · s) of resin | | ratio (1 | respect to MEK | | ratio (3 | Uniformity of resin sheet | |
| | composition | | rpm/10 | After 3 | After 13 | seconds/13 | Thickness | Thickness |
| | 1 rpm | 10 rpm | rpm) | seconds | seconds | seconds) | of 3 μm | of 80 μm |
| Example | 33.2 | 9.2 | 3.609 | 23.4 | 22 | 1.064 | Uniform | Colorless |
| 1-1 | | | | | | | | transparency |
| Example | 0.4 | 0.36 | 1.111 | 22.8 | 16.9 | 1.349 | Uniform | Colorless |
| 1-2 | | | | | | | | transparency |
| Example | 107 | 22.32 | 4.794 | 30.9 | 32.5 | 0.951 | Uniform | Colorless |
| 1-3 | | | | | | | | transparency |
| Example | 1.2 | 1 | 1.2 | 29.7 | 29.3 | 1.014 | Uniform | Colorless |
| 1-4 | | | | | | | | transparency |
| Example | 45.6 | 12.84 | 3.551 | 30 | 31.8 | 0.943 | Uniform | Colorless |
| 1-5 | | | | | | | | transparency |
| Example | 34.8 | 10.28 | 3.385 | 28.3 | 27.7 | 1.022 | Uniform | Colored |
| 1-6 | | | | | | | | transparency |
| Example | 0.8 | 1.08 | 0.741 | 29.8 | 29.9 | 0.997 | Uniform | Colored |
| 1-7 | | | | | | | | transparency |
| Example | 1.2 | 1.08 | 1.111 | 31.8 | 26.8 | 1.187 | Non- | Cloudy |
| 1-8 | | | | | | | uniform | |
| Example | 1.2 | 1 | 1.2 | 33.4 | 28 | 1.193 | Non- | Cloudy |
| 1-9 | | | | | | | uniform | |
| Example | 0 | 0.08 | 0 | 15.3 | 8.4 | 1.821 | Uniform | Colorless |
| 1-10 | | | | | | | | transparency |
| Example | 0 | 0.08 | 0 | 14.6 | 7.2 | 2.028 | Uniform | Colorless |
| 1-11 | | | | | | | | transparency |
| Example | 0.4 | 0.24 | 1.667 | 25.9 | 21.9 | 1.183 | Uniform | Colored |
| 1-12 | | | | | | | | transparency |
| Example | 0 | 0.12 | 0 | 18.9 | 11.4 | 1.658 | Uniform | Colored |
| 1-13 | | | | | | | | transparency |

TABLE 3

| | Evaluation results | | | |
|---|---|---|---|---|
| | Weight average | Contact angle (° C.) of resin | | |
| | molecular weight | sheet with respect to water | | |
| | (Mw) of resin | After 3 | After 8 | After 13 |
| | component (II) | seconds | seconds | seconds |
| Example 1-1 | 220000 | 97.20 | 96.30 | 96.30 |
| Example 1-2 | 187000 | 92.00 | 91.30 | 91.30 |
| Example 1-3 | 166000 | 101.70 | 101.40 | 101.40 |
| Example 1-4 | 139000 | 109.80 | 109.60 | 109.60 |
| Example 1-5 | 190000 | 105.90 | 105.70 | 105.70 |
| Example 1-6 | 250000 | 106.00 | 105.80 | 105.80 |
| Example 1-7 | 205000 | 110.40 | 110.10 | 110.10 |
| Example 1-8 | 284000 | 113.70 | 113.70 | 113.70 |
| Example 1-9 | 255000 | 117.60 | 117.50 | 117.50 |
| Example 1-10 | 187000 | 103.50 | 103.30 | 103.30 |
| Example 1-11 | 155000 | 102.80 | 102.60 | 102.60 |
| Example 1-12 | 77000 | 116.00 | 115.80 | 115.80 |
| Example 1-13 | 63700 | 112.70 | 112.30 | 112.30 |

As shown in Tables 1 to 3, in Examples 1-1 to 1-13, the viscosity of the BCA solution was 0.08 to 22.32 Pas, and the solubility of the resin composition with respect to BCA was favorable.

In addition, in Examples 1-1 to 1-13, the contact angle ratio (3 seconds/13 seconds) of MEK was 0.943 to 2.028.

In addition, in Examples 1-1 to 1-7, 1-10 to 1-13, the resin sheet having a thickness of 3 μm had high uniformity in thickness, and the resin sheet having a thickness of 80 μm had colorless transparency. In Examples 1-8 to 1-9, the thickness of the resin sheet having a thickness of 3 μm was partially non-uniform, and the resin sheet having a thickness of 80 μm was cloudy.

As described above, the resin compositions of Examples 1-1 to 1-13 had favorable solubility in the solvent, and the resin sheets of Examples 1-1 to 1-13 had favorable stretchability because the resin component (II) had a urethane bond. That is, these resin sheets were suitable for forming elements, wirings or electrodes in stretchable device, and particularly suitable for forming wirings or electrodes.

In addition, since the resin sheets of Examples 1-6 to 1-7 also had appropriate water repellency, hydrolysis of the urethane bond was minimized and an effect of minimizing deterioration over time was strong.

### Test Example 2

The raw materials used for producing the resin composition are shown below.

Regarding the resin (a), the resin (b), the polymerization initiator (c), the RAFT agent, and other polymerizable components, the same ones from Test Example 1 were used. Regarding the solvent, methyl ethyl ketone (MEK) or butyl carbitol acetate (BCA) was used.

### Example 2-1

### <Production of Resin Composition>

The resin (a)-1 (100 parts by mass), the resin (b)-1 (2 parts by mass), the polymerization initiator (c)-1 (1.2 parts by mass), the RAFT agent (1)-1 (2.946 parts by mass), and MEK were weighed out in a flask, and these were mixed at room temperature using a stirrer, and thereby a raw material mixture was obtained.

In the present disclosure, the formulation amounts of the resin (b), the polymerization initiator (c), and the RAFT agent with respect to 100 parts by mass of the resin (a)+other polymerizable components were determined. However, since no other polymerizable components were used in Example 1, the formulation amounts of the resin (b), the polymerization initiator (c), and the RAFT agent with respect to 100 parts by mass of the resin (a) were determined.

In addition, the solvent MEK was mixed so that 100 parts by mass of the resin (a) was 25 mass % of the raw material mixture.

Next, using liquid nitrogen, the obtained raw material mixture was cooled and solidified, and the inside of the closed flask was vacuum-deaerated.

Next, in a nitrogen atmosphere, using an oil bath, the raw material mixture was dissolved, the temperature was continuously raised with stirring, a polymerization reaction was caused at 90° C. for 55 minutes, and thus a resin component (I) was produced and also a resin composition containing the resin component (I) was produced.

### <Evaluation of Resin Composition>

### (Measurement of Weight Average Molecular Weight of Resin Component (I))

The weight average molecular weight (Mw) of the resin component (I) obtained above was measured by the same method as in Test Example 1. The weight average molecular weight was calculated using a calibration curve created in advance. The results are shown in Table 6.

### (Measurement of Viscosity of Resin Composition and Calculation of Viscosity Ratio (1 Rpm/10 Rpm))

The viscosity (viscosity (1 rpm)) was measured by the same method as in Test Example 1. In addition, after being left for 1 minute, the viscosity (viscosity (10 rpm)) was measured with stirring at a stirring speed of 10 rpm. Then, the viscosity ratio (1 rpm/10 rpm) was calculated. The results are shown in Table 5.

### <Production of Resin Sheet>

Using an applicator, the resin composition obtained in Example 2-1 was applied onto a release film and dried at 25° C. for 18 minutes, and thus a resin sheet (test resin sheet with a thickness of 2 μm) was produced without performing a curing reaction.

### <Evaluation of Resin Sheet>

(Measurement of Contact Angle with Respect to Water)

By the same method as in Test Example 1, the contact angle with respect to water was measured in stages in which the time after attachment was 3 seconds, 8 seconds and 13 seconds. The results are shown in Table 6.

(Measurement of Contact Angle with Respect to MEK and Calculation of Contact Angle Ratio (3 Seconds/13 Seconds))

By the same method as in Test Example 1, the contact angle with respect to MEK in stages in which the time after attachment was 3 seconds and 13 seconds was measured, and the contact angle ratio (3 seconds/13 seconds) was calculated. The results are shown in Table 5.

### <Production and Evaluation of Resin Composition and Production and Evaluation of Resin Sheet>

### Examples 2-2 to 2-16

Resin compositions were produced and evaluated, and resin sheets were produced and evaluated in the same methods as in Example 2-1 except that one or both of the type and the formulation amounts of compounding components of the raw material mixture for obtaining the resin composition or the polymerization reaction time was changed as shown in Table 4.

In Examples 2-2 to 2-16, with respect to 100 parts by mass of the resin (a)+other polymerizable components, the resin (b), the polymerization initiator (c), and the RAFT agent in formulation amounts shown in Table 1 were mixed.

Here, in Examples 2-4 and 2-5, the resin (a)+other polymerizable components=140 parts by mass was shown, but this was converted into 100 parts by mass, and the resin (b), the polymerization initiator (c), and the RAFT agent in the formulation amounts shown in Table 1 were mixed.

In addition, in Examples 2-2 to 2-13, the solvent MEK was mixed so that 100 parts by mass of the resin (a)+other polymerizable components was 25 mass % of the resin composition. In Examples 2-14 to 2-16, the solvent BCA was mixed so that 100 parts by mass of the resin (a)+other polymerizable components was 15 mass % of the raw material mixture.

Regarding production of the resin sheet, in Examples 2-2 to 2-13, the resin sheet was produced by the same method as in Example 2-1.

In Examples 2-14 to 2-16, regarding the resin composition containing BCA, using an applicator, the resin composition obtained above was applied onto a release film and dried at 115° C. for 60 minutes, and thus a resin sheet (test resin sheet with a thickness of 2 μm) was produced without performing a curing reaction.

In Table 4, “-” in the column of “compounding component (parts by mass) of raw material mixture” indicates that the component is not added. In addition, regarding the “solvent,” the formulation amount thereof is not described.

TABLE 4

| | Compounding components of raw material mixture (parts by mass) | | | | | | Polymerization | |
|---|---|---|---|---|---|---|---|---|
| | | | | | Other | | reaction | |
| | Resin | Resin | Polymerization | RAFT | polymerizable | | Temperature | Time |
| | (a) | (b) | initiator (c) | agent | component | Solvent | (° C.) | (min) |
| Example | (a)-1 | (b)-1 | (c)-1 (1.2) | (1)-1 | — | MEK | 90 | 55 |
| 2-1 | (100) | (2) | | (2.946) | | | | |
| Example | (a)-1 | (b)-1 | (c)-1 (1.2) | (1)-1 | — | MEK | 90 | 50 |
| 2-2 | (100) | (0.35) | | (2.946) | | | | |
| Example | (a)-1 | (b)-1 | (c)-1 (1.2) | (3)-1 | — | MEK | 90 | 50 |
| 2-3 | (100) | (0.35) | | (3.158) | | | | |
| Example | (a)-1 | (b)-1 | (c)-1 (1.2) | (1)-1 | MMA (40) | MEK | 90 | 60 |
| 2-4 | (100) | (2) | | (0.368) | | | | |
| Example | (a)-1 | (b)-1 | (c)-1 (1.2) | (3)-1 | MMA (40) | MEK | 90 | 60 |
| 2-5 | (100) | (2) | | (0.395) | | | | |
| Example | (a)-1 | (b)-1 | (c)-1 (1.2) | (1)-1 | — | MEK | 90 | 50 |
| 2-6 | (100) | (5) | | (2.946) | | | | |
| Example | (a)-1 | (b)-1 | (c)-1 (1.2) | (1)-1 | — | MEK | 90 | 50 |
| 2-7 | (100) | (10) | | (2.946) | | | | |
| Example | (a)-1 | (b)-1 | (c)-1 (1.2) | (1)-1 | — | MEK | 90 | 50 |
| 2-8 | (100) | (15) | | (2.946) | | | | |
| Example | (a)-1 | (b)-1 | (c)-1 (1.2) | (3)-1 | — | MEK | 90 | 50 |
| 2-9 | (100) | (15) | | (3.158) | | | | |
| Example | (a)-1 | (b)-1 | (c)-1 (1.2) | (1)-1 | — | MEK | 90 | 50 |
| 2-10 | (100) | (2) | | (3.682) | | | | |
| Example | (a)-1 | (b)-1 | (c)-1 (1.2) | (3)-1 | — | MEK | 90 | 50 |
| 2-11 | (100) | (2) | | (3.947) | | | | |
| Example | (a)-1 | (b)-1 | (c)-1 (1.2) | (1)-1 | — | MEK | 90 | 8 |
| 2-12 | (100) | (2) | | (0.05) | | | | |
| Example | (a)-1 | (b)-1 | (c)-1 (1.2) | (3)-1 | — | MEK | 90 | 8 |
| 2-13 | (100) | (2) | | (0.05) | | | | |
| Example | (a)-1 | (b)-1 | (c)-1 (2.4) | (1)-1 | — | BCA | 90 | 180 |
| 2-14 | (100) | (1.5) | | (3.682) | | | | |
| Example | (a)-1 | (b)-1 | (c)-1 (2.4) | (3)-1 | — | BCA | 90 | 180 |
| 2-15 | (100) | (1.5) | | (3.947) | | | | |
| Example | (a)-1 | (b)-1 | (c)-1 (0.8) | (1)-1 | — | BCA | 90 | 20 |
| 2-16 | (100) | (1.5) | | (0.245) | | | | |

TABLE 5

| | Evaluation results | | | | | |
|---|---|---|---|---|---|---|
| | | | | Contact angle (° C.) | | Contact |
| | Viscosity | | | of resin sheet with | | angle |
| | (Pa · s) of resin | | Viscosity | respect to MEK | | ratio (3 |
| | composition | | ratio (1 | After 3 | After 13 | seconds/13 |
| | 1 rpm | 10 rpm | rpm/10 rpm) | seconds | seconds | seconds) |
| Example | 10 | 7.48 | 1.34 | 25.2 | 22.8 | 1.105 |
| 2-1 | | | | | | |
| Example | 6.8 | 5.36 | 1.27 | 27.3 | 23.3 | 1.172 |
| 2-2 | | | | | | |
| Example | 0.4 | 0.24 | 1.67 | 23.8 | 17.9 | 1.330 |
| 2-3 | | | | | | |
| Example | 0.1 | 0.12 | 0.83 | 24.1 | 19.9 | 1.211 |
| 2-4 | | | | | | |
| Example | 0.4 | 0.3 | 1.33 | 24.5 | 20 | 1.225 |
| 2-5 | | | | | | |
| Example | 8.8 | 6.88 | 1.28 | 30.2 | 23.9 | 1.264 |
| 2-6 | | | | | | |
| Example | 29.6 | 17.4 | 1.70 | 29.9 | 23 | 1.300 |
| 2-7 | | | | | | |
| Example | 21.6 | 13.92 | 1.55 | 29.2 | 22.9 | 1.275 |
| 2-8 | | | | | | |
| Example | 0 | 0.04 | 0.00 | 25.7 | 19 | 1.353 |
| 2-9 | | | | | | |
| Example | 9.6 | 7.72 | 1.24 | 29 | 22.7 | 1.278 |
| 2-10 | | | | | | |
| Example | 0.4 | 0.32 | 1.25 | 25.4 | 18.9 | 1.344 |
| 2-11 | | | | | | |
| Example | 0.8 | 0.8 | 1.00 | 27.6 | 21.8 | 1.266 |
| 2-12 | | | | | | |
| Example | 0.4 | 0.36 | 1.11 | 26.3 | 21 | 1.252 |
| 2-13 | | | | | | |
| Example | 0.4 | 0.24 | 1.67 | 25.9 | 21.9 | 1.183 |
| 2-14 | | | | | | |
| Example | 0.1 | 0.12 | 1.67 | 18.9 | 11.4 | 1.658 |
| 2-15 | | | | | | |
| Example | 34.8 | 10.28 | 1.67 | 28.3 | 27.7 | 1.022 |
| 2-16 | | | | | | |

TABLE 6

| | Evaluation results | | | |
|---|---|---|---|---|
| | Weight average | Contact angle (° C.) of resin | | |
| | molecular weight | sheet with respect to water | | |
| | (Mw) of resin | After 3 | After 8 | After 13 |
| | component (I) | seconds | seconds | seconds |
| Example 2-1 | 150000 | 103.5 | 102.7 | 103.3 |
| Example 2-2 | 61400 | 80.1 | 79.4 | 78.7 |
| Example 2-3 | 52200 | 77.7 | 77.1 | 76 |
| Example 2-4 | 135000 | 105.3 | 105.3 | 105.3 |
| Example 2-5 | 115000 | 105 | 104.7 | 104.6 |
| Example 2-6 | 150000 | 105.9 | 105.3 | 104.8 |
| Example 2-7 | 145000 | 105.2 | 105.1 | 105 |
| Example 2-8 | 135000 | 105.5 | 105.5 | 105.3 |
| Example 2-9 | 108000 | 93.5 | 92.8 | 93.3 |
| Example 2-10 | 75000 | 104.5 | 104.2 | 104.2 |
| Example 2-11 | 60000 | 94.1 | 93.9 | 93.3 |
| Example 2-12 | 163000 | 105.6 | 105.4 | 105.2 |
| Example 2-13 | 142000 | 103.3 | 103.1 | 102.8 |
| Example 2-14 | 77700 | 116 | 115.8 | 115.8 |
| Example 2-15 | 63700 | 112.7 | 111.2 | 112.3 |
| Example 2-16 | 250000 | 106 | 105.8 | 105.8 |

As shown in Table 6, in Examples 2-1 to 2-16, while the time after attachment of pure water was 3 to 13 seconds, the contact angle of the resin sheet with respect to water was 76° to 112.7°, and the resin sheet had appropriate water repellency.

As described above, the resin sheets of Examples 2-1 to 2-16 had favorable stretchability because the resin component (I) had a urethane bond, and also had appropriate water repellency so that hydrolysis of the urethane bond was minimized and deterioration over time was minimized. That is, these resin sheets were suitable for forming elements in stretchable devices.

### INDUSTRIAL APPLICABILITY

The present disclosure can be used for stretchable devices and production thereof.

### REFERENCE SIGNS LIST

1 Laminated body
10 Resin sheet
11 First sheet
12 Second sheet
13 Third sheet
14 Fourth sheet
111 Electrode
121 Copper-plated member
131 Electronic component

1. A resin composition, wherein a resin component in the resin composition has a group represented by the following General Formula (11), (21) or (31) and a urethane bond: 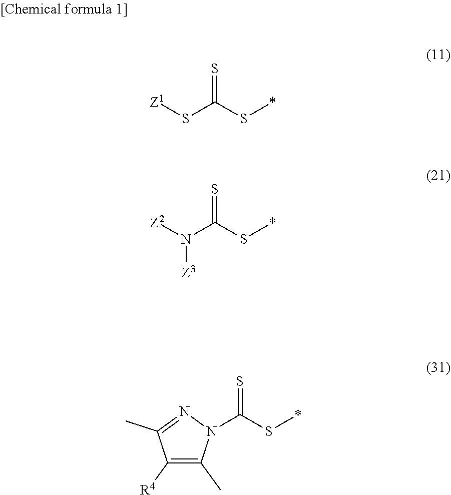
(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).

2. The resin composition according to claim 1, wherein a viscosity of a butyl carbitol acetate solution containing 15 mass % of the resin composition is 0.07 to 22.35 Pa·s, when the butyl carbitol acetate solution is adjusted to a temperature of 25° C. and the viscosity of the butyl carbitol acetate solution is measured while stirring at a stirring speed of 10 rpm.

3. The resin composition according to claim 2, wherein the resin composition contains a resin component having a weight average molecular weight of 61,000 to 250,000.

4. The resin composition according to claim 1,
wherein the resin component in the resin composition further has a siloxane bond, and
the contact angle of a test resin sheet, which is obtained by solidifying the resin composition by drying, with respect to water is 77° to 116°.

5. The resin composition according to claim 4, wherein the resin composition contains a resin component having a weight average molecular weight of 52,000 to 250,000.

6. A laminated body comprising a resin sheet obtained by solidifying the resin composition according to claim 1 by drying.

7. The laminated body according to claim 6, in addition to the resin sheet, further comprising a substrate layer containing a resin.
